(19) United States
(12) Patent Application Publication
(10) Pub. No.: US 2026/0253493 A1
(43) Pub. Date: Aug. 27, 2026

(54) TRAFFIC MESSAGING AND INFORMATION SYSTEM

(71) Applicant: Andrew L Butler, Linden, NJ (US)

(72) Inventor: Andrew L Butler, Linden, NJ (US)

(21) Appl. No.: 19/535,275

(22) Filed: Feb. 10, 2026

Related U.S. Application Data
(60) Provisional application No. 63/762,719, filed on Feb. 25, 2025.

(51) Int. Cl. G08G 1/095; G08G 1/07

(52) U.S. Cl. CPC G08G 1/095; G08G 1/07

(57) ABSTRACT

A traffic messaging and information system utilizes a traffic light control device which alternatively switches on a red stop light and after a time interval switches off the stop light and turns on a green light, and after a second time interval, switches off the green light and switches on the red light. When the traffic light control device exhibits a red light, messages and information will automatically display on a digital screen, which allows stopped vehicles to see the messages and information. When the traffic light control device changes to a green light, the system will automatically cause the screen to go blank, as vehicles proceed past the traffic control device.

### RELATED APPLICATION

This application claims the benefit of provisional application, Ser. No. 63/762,719, filed on Feb. 25, 2025.

### FIELD OF THE INVENTION

The present invention relates to the display of advertisements, public notifications, traffic instructions and directions, stolen car alerts, and the like, integrated into traffic light contral devices.

### BACKGROUND OF THE INVENTION

Advertisements, for instance in the form of billboards, are often positioned in high trafficked locations, such as along the sides of highways. Outdoor electronic advertisements and message boards are now becoming more prevalent, as the messages on the boards can be automatically changed by transmission of remote signals and similar means. However, these prior messaging systems are limited in their capacity to display a vast variety of information. More importantly, current roadside displays are a distraction to motorists whose concentration is diverted, as they look at these displays while and instead of concentrating on driving. There is currently no system which effectively accomplishes the dual objectives of providing a variety of roadside messaging while ensuring that drivers can safely read and observe messages and information.

### SUMMARY OF THE INVENTION

It is thus the object of the present invention to provide a traffic messaging and information system which addresses the limitations and disadvantages of existing systems.

It is an object of a present invention to provide a traffic messaging and information system which has the ability to display important public notifications, including Amber alerts, stolen car information, current traffic accidents, etc.

It is a further object of the present invention to provide a traffic messaging and information system which is capable of displaying the speed of traffic in order to assist in preventing accidents.

It is still another advantage object of the present invention to provide a traffic messaging and information system which displays advertisements, while assisting in preventing driver distractions caused by driver inattention to road conditions.

It is another object of the president invention to provide a traffic messaging and information system which assists in preventing driver distraction due to cell phone usage while waiting at red lights.

It is still another object of the present invention to provide a traffic and messaging information system which has the ability to receive downloadable data and sequentially and simultaneously display messages of all types.

It is a further object of the present invention to provide a traffic messaging and information system which has the ability to generate recurring revenue for municipalities.

These and other objects are accomplished by the present invention, a traffic messaging and information system which comprises a traffic light control device which alternatively switches on a red stop light and after a time interval switches off the stop light and turns on a green light, and after a second time interval, switches off the green light and switches on the red light. When the traffic light control device exhibits a red light, messages and information will automatically display on a digital screen, which allows stopped vehicles to see the messages and information. When the traffic light control device changes to a green light, the system will automatically cause the screen to go blank, as vehicles proceed past the traffic control device.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a schematic disclosing the interrelationship of the various primary components of the system of the present invention.

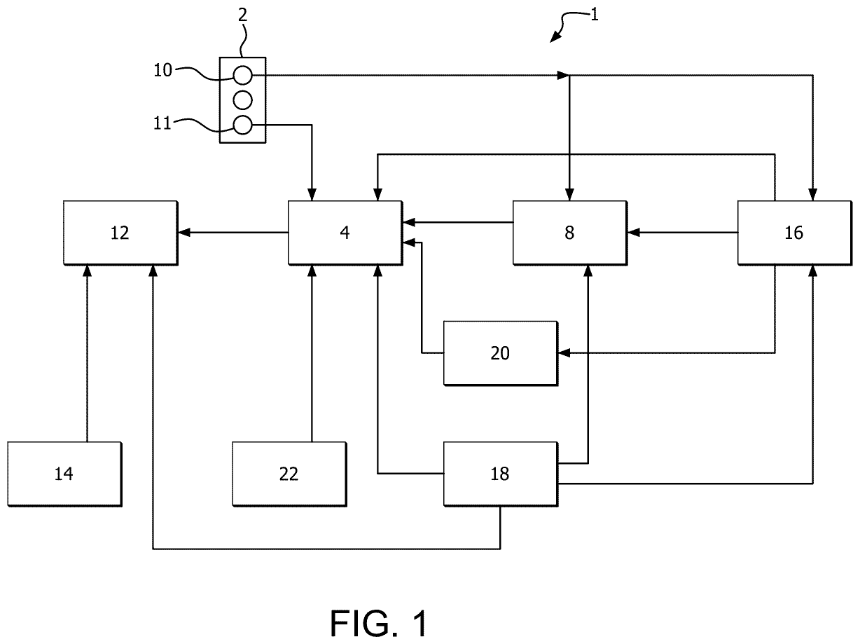

FIG. 2 illustrates the operation of the system of the present invention and its effect on traffic when the traffic light control device indicates a red (stop) light.

FIG. 3 illustrates the operation of the system of the present invention and its effect on traffic when the traffic light control device indicates a green (go) light.

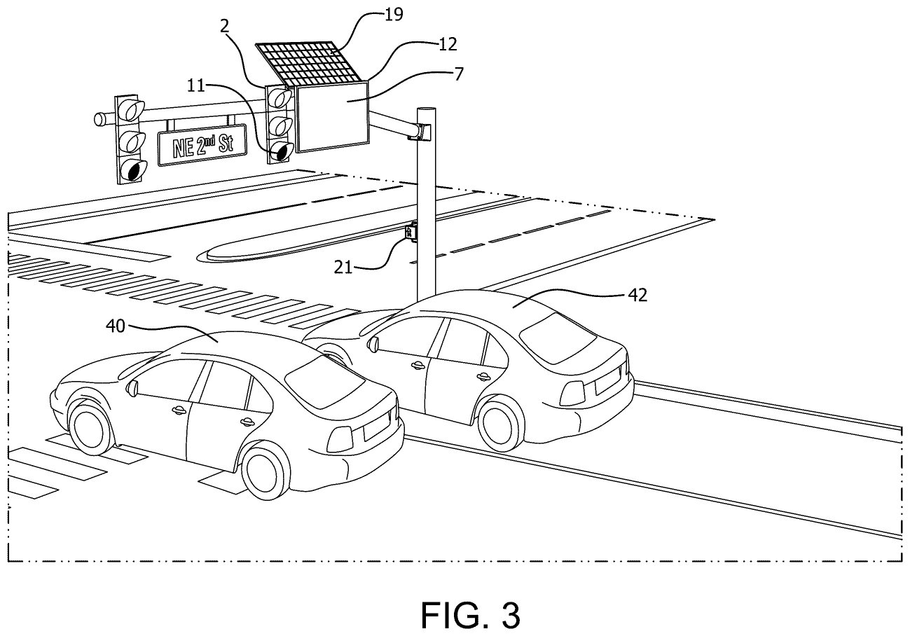

FIG. 4 illustrates the operation of the system of the present invention and its effect on traffic when the traffic light control device, located in combination with the system's digital screen, indicates a red (stop) light.

### DETAILED DESCRIPTION OF THE INVENTION

The digital traffic light messaging and information system 1 of the present invention is designed to be installed in combination with a traffic light control device such as traffic light 2. The system utilizes a media player 4 which displays messages and information 6 on digital screen 12. Digital camera 8 utilizing specialized algorithms is used to transmit a system actuation signal to media player 4 when traffic light 2 turns to a “stop” signal, such as red light 10, and when the traffic light turns to a “go” signal, such as green light 11. Media player 4 next transmits a signal to digital screen 12 to begin displaying messages and information 6. Media player 4 is wired directly to the digital screen 12, making it possible for the messages to be displayed on the screen. Digital color sensor 16 may also be employed independently or may be used in tandem with camera 8, to send signals to media player 4 to show messages 6 on digital screen 12 when there is a “stop” signal, e.g. red light 10, and to send signals to the media player to cease sending messages to the digital screen when there is a “go” signal, e.g. green light 11. Message and informational data 22 is formulated and transmitted to media player 4 via GPS, Wi-Fi, cellular signal, or similar known technologies.

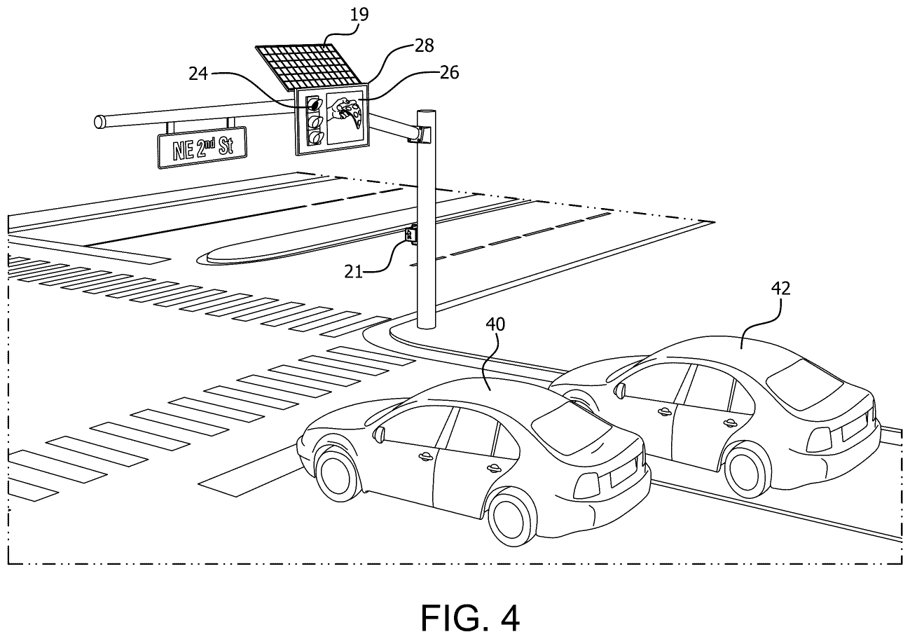

While the traffic light control device could take the form of a singular, independent unit, such as traffic light 2, it is contemplated that the traffic light control device 24 and digital screen 26 would be combined into one, self-contained digital screen unit 28, as shown in FIG. 4. In this configuration, messages and information 30 would be shown adjacent to traffic light control device 24.

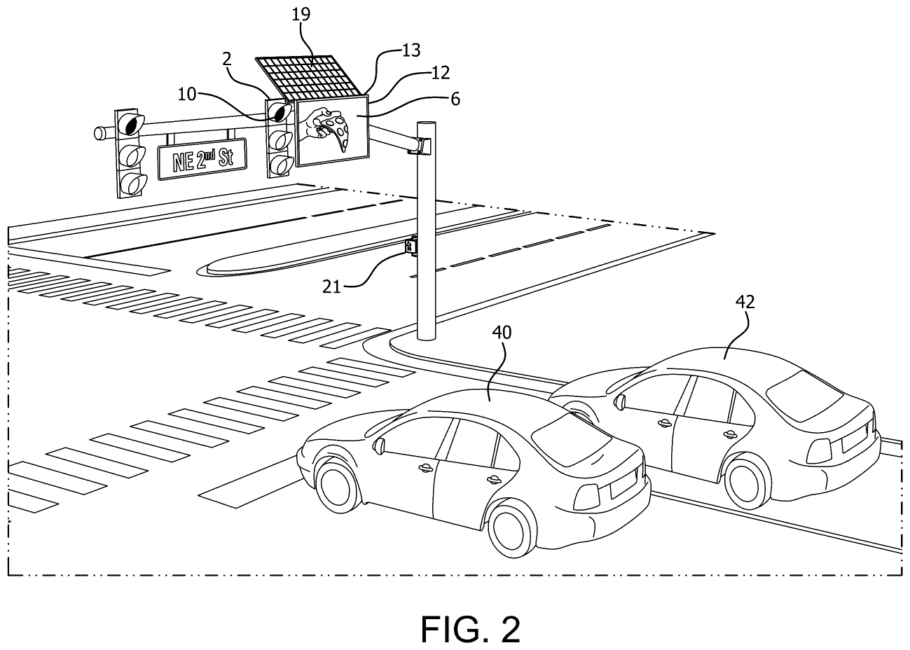

In operation, traffic control device 2 is set to alternatively turn on vehicle stop signal 10, and after a time interval switch off the stop signal and turn on vehicle go signal 11. After a second time interval, go signal 11 would be switched off and stop signal 10 would be turned on. In this way, when traffic light control device 2 exhibits a stop signal, e.g. red light 10, system 1 will send a signal via media player 4, to display messages and information 6 on screen 12, which allows stopped vehicles 40 and 42 to see the messages and information as seen in FIG. 2. When traffic light control device 2 changes to a go signal, e.g. green light 11, system 1 will send a signal via media player 4 to screen 12, causing it to go blank 7, as vehicles 40 and 42 proceed past the traffic control device.

Digital screen 12 will be fitted inside a metal or security grade, plastic or other durable material enclosure 13 with a see-through security grade, durable plastic, or like material window. It will be equipped with heating and cooling, and humidity control systems, and anti-glare technology 14.

The system will be hardwired and electrical power 18 will be provided by the local municipality. Power could also be supplied by a battery 20 contained within a securable insulated battery cabinet 21 that may be installed on or adjacent to a vertical pole of the traffic control device. It is anticipated that solar power 19 could also be used to provide electricity to the system.

Artificial Intelligence may be utilized to organize digital screens used as traffic control devices. This will ensure that they operate sequentially to prevent disruptions to normal traffic patterns and to make the system more logistically efficient.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A traffic messaging and information system comprising:
a traffic light control device which comprises a vehicle stop signal and a vehicle go signal, the traffic light control device being set to alternatively turn on the vehicle stop signal and after a time interval switch off the vehicle stop signal and turn on the vehicle go signal, and then after a second time interval, switch off the vehicle go signal and turn on the vehicle stop signal;
a digital screen;
a media player which displays messages and information on the digital screen;
a digital camera configured to transmit an actuation signal to the media player to show messages and information on the digital screen when the vehicle stop signal is on and the vehicle go signal is off, and to blank the digital screen when the vehicle stop signal is off and the vehicle go signal is on;
an information data source to transmit messages and information to the media player; and
an energy source to power the system.

2. The traffic messaging an information system as in claim 1 wherein the traffic light control device is a singular traffic light unit.

3. The traffic messaging and information system as in claim 1 wherein the traffic light control device is located on a section of the digital screen, which forms a self-contained digital screen.

4. The traffic messaging and information system as in claim 1 further comprising a digital color sensor used in tandem with or independently of the digital camera to transmit signals to the media player.

5. The traffic messaging and information system as claim 1 wherein the digital screen is fabricated within a waterproof, metal, security grade enclosure with a see-through durable, security grade anti-glare window.

6. The traffic messaging and information system as in claim 1 wherein the energy source is an electrical battery.

7. The traffic messaging and information system is in claim 1 wherein the energy source is provided by an outside electric power, with the system being electrically hardwired.

8. The traffic messaging and information system as in claim 1 wherein solar panels provide electricity as the source of power.

9. The traffic messaging and information system as in claim 1 wherein the vehicle stop and go signals are red and green lights respectively.

10. The traffic messaging and information system as in claim 1 wherein messages and information are formulated and transmitted to the media player by GPS, WiFi, cellular or equivalent technologies.

11. The traffic messaging and information system as in claim 1 wherein the digital screen is equipped with heating, cooling and humidity control systems and anti-glare technology.
